(19) United States
(12) Patent Application Publication
(10) Pub. No.: US 2004/0140134 A1
(43) Pub. Date: Jul. 22, 2004

(54) Portable electronic onboard truck scaling process

(76) Inventor: David K. Dohrmann, So Hutchinson, KS (US)

Correspondence Address: David K Dohrmann, 11 North Valley Pride Road, South Hutchinson, KS, 67505, US

(21) Appl. No.: 10/349,438

(22) Filed: Jan. 22, 2003

(51) Int. Cl. G01G 19/22

(52) U.S. Cl. 177/25.13; 177/136

(57) ABSTRACT

Traditional electronic onboard scaling patents teach methods of attaching only permanent components to a vehicle to determine axle or vehicle weight. This patent teaches a method of using a combination of low-cost permanently attached components and a more expensive Portable Electronic Meter that can be shared between the multiple vehicles.

The system is comprised of a quick-coupler fitting assembly with a Protective Cap that is permanently attached to a vehicle in a location that a Portable Meter can be attached. Inside the Protective Cap is a memory device that stores historical reference information. The permanently mounted component is non-powered and doesn't require any electrical connection to the vehicle.

The Portable Meter has a sensor and battery located inside it and a mating quick-coupler fitting outside it. It is hand carried to a Protective Cap and positioned so cap identification, the reference weights and the pressures within the Caps memory can be transferred between the Protective Cap and a Portable Meter through the unique circuitry created by the components.

The Portable Meter is temporarily connected to the quick-coupler of the Meter Connect permanently located on the tractor and/or trailer so that the air bag suspension pressure can be read, converted and displayed to the operator in meaningful axle weight units.

If the weight estimate to be made is outside of the pressure range defined by the historical reference data for that axle, the Portable Meter delivers a warning to the driver that the weight estimate is outside of the weight estimating range. If the driver continues with the weight estimate, he does so with a lower level of confidence in the accuracy of the weight estimate being as it has not been modeled by historical reference weights.

### STATEMENT REGARDING FEDERALLY SPONSERED RESEARCH AND DEVELOPMENT

Not Applicable

### CROSS REFFERENCE TO RELATED APPLICATIONS

Not Applicable

### BACKGROUND OF THE INVENTION

The trucking industry is constantly searching for ways to improve productivity, lower their costs, and increase the security of a load in transit. Onboard truck scales are playing an important role to meet these ends.

The biggest challenge to industry wide implementation of onboard scales has been logistical in nature. The product and subsequent process of measuring, which are the subject of this patent, addresses and overcomes these industry logistical problems by the introduction of a truly unique product.

From the industry viewpoint, a large percentage of companies own their trailers but not the tractors in an attempt to variablize their costs. Companies will contract drivers or smaller companies to pull their trailers and deliver the loads. These contract drivers are called Owner-Operators. Convincing a company and perhaps several thousand Owner Operator drivers that work for that company to all purchase compatible equipment has made implementing an onboard truck scale system across any fleet difficult. Compounding the problem has been that Owner-Operator and company employee driver turnover within the industry range from 50-200% yearly.

Secondarily, the high price of traditional electronic onboard scaling systems has also limited their implementation. Implementing traditional electronic onboard scaling systems has involved convincing both the company and the drivers to independently purchase relatively expensive components when neither one knows how long the driver will remain with the company.

Electronic onboard scales have the advantage of higher accuracy and can usually scale any of the tractor and trailer axles. As pointed out in several existing patents, traditional electronic onboard scaling is a process of committing a sensor mounted to a vehicle that monitors a variable that can be correlated to weight. The sensor inputs are transmitted to a processor unit and then through wires, or other parasitic burst serial communication to a Traditional Electronic Scale Meter, or data acquisition box that is powered by the vehicle. In some cases, several Traditional Meters or data acquisition boxes can be connected together such that all data can be read from a single Traditional Meter.

By comparison, this onboard scale does not tap into vehicle power but is battery powered and has no vehicle powered electronics. Placing a self-generated voltage between the components introduced by this patent, initiates communication and electrical flow only between the components and not to the vehicle. Unlike other patents, the communication does not rely on existing vehicle wiring or the vehicle frame as an electrical conductor. Most importantly, the signal being communicated is not current sensor output.

Traditional technology, as outlined in all previous patents, requires that the sensor, monitoring the axle weight, is permanently attached to the vehicle. The Traditional Meter or data acquisition box is also permanently attached to the vehicle. In some cases, one Traditional Meter is permanently and electrically connected to monitor several sensors as a way to reduce the monitoring costs per observation.

This patent removes the sensor from the vehicle entirely sharing it between several axles or axle groups on a vehicle, several vehicles within a company, or any vehicle in any company.

Previous patents have taught how the calibration of traditional electronic onboard scales is done by obtaining an empty axle weight in combination with a reference weight that is stored in a Traditional Meter or data acquisition box for each axle group being sensed. This patent outlines how identifying and entering the empty axle weight for every vehicle is not only logistically impractical for large fleets, but lowers the accuracy obtained. Instead, a shorter, more practical line segment of reference axle weights defining the working range from mid to full weight or whatever axle weights the driver needs, improves axle weight estimating accuracy. It also makes obtaining reference weights easier because the empty axle weight is not required for each vehicle. When an axle weight estimate is required that is outside the reference weight end points, the scale warns the driver about the potential inaccuracy of using the scale in a working range that has not been modeled. If a wider range of axle weight estimates is required, the driver can obtain a new reference weight to include this range. If a driver requires a full range of axle weights, more reference weights may be added within the working range used by the driver transforming the calculation into a non-linear function.

The typical cost of an electronic onboard truck scale on a trailer is ten times the cost of the Meter Connect used on a trailer and described in this patent. Trailers are spending more time unattached from a tractor waiting for loading or loading at some remote location. Often company trailers will spend days or weeks in other countries with lower levels of law enforcement making them vulnerable to thieves that steal expensive, easily accessed trailer components. As a result, trucking companies are reluctant to purchase expensive electronic onboard truck scales.

Another solution for the industry has been to install low priced, low accuracy air gages. These are used in a way where the driver learns over time what air pressure is displayed when they are carrying a full load. The driver remembers this pressure and references it on subsequent loads.

Some air gages are modified so the decal on the face of the air gage reads an approximation of axle weight rather than air pressure in pounds per square inch. These weight gages are also low cost and their accuracy is within 2-5% similar to a typical air gage. It is impossible to read weight or air gages in small axle weight increments for great accuracy like electronic onboard scales. Additionally, gage repeatability is not very good and greatly effected by gage age so large weight estimate errors are normal. Weight estimate errors of this size are generally not satisfactory to the driver but the low price is irresistibly low.

When calibrating weight gage scales, the axle group must be at the targeted full load weight. The weight gage face is then rotated so that the sweep-hand, usually pointing to the air pressure value, now points to the estimated axle weight value displayed on the face decal as defined by a platform scale weight.

By considering only one data point in modeling axle weight, non-electronic onboard scale logic form a go, no-go gage for axle weights. A driver knows if he is over or under a targeted weight but does not how much they are over or under the targeted weight. As a result, the driver can not attempt to make accurate weight estimates over a broad application of axle weights.

The products of the previous patents left an industry needing an onboard scale with the accuracy of the electronic scales, but the low cost and simplicity of use of an air gage or weight gage. We have combined the best of both technologies into a low cost, durable, and accurate monitoring methodology.

### BRIEF SUMMARY OF THE INVENTION

The object of this invention is to teach a method of using a combination of low-cost components permanently attached to a vehicle and a more expensive Portable Electronic Meter that can be shared between the multiple vehicles.

Another object of this process of onboard truck scaling without a sensor permanently attached or included as part of an assembly that is permanently attached to a vehicle that may or may not be powered from the vehicle.

A process of onboard truck scaling not tapping into electrical wiring currently existing on a vehicle or using the vehicle frame as an electrical conductor for the purpose of powering, data transfer, or communications.

Another object of this invention is to teach that the only asset permanently mounted to the tractor and/or trailer is a low cost, quick-coupler fitting in a mounting assembly with a Protective Cap that protects the quick-coupler fitting. This assembly permanently mounted to the tractor and/or trailer is collectively called a Meter Connect.

Sharing the cost of one Portable Meter between the tractor and trailer Meter Connects reduces the total cost to both trailer and tractor owners and more importantly, splits the cost between them.

Another object of this invention is to teach that the Protective Cap on the Meter Connect has another, more important purpose. Inside the Protective Cap is a memory device in a weather resistant assembly. Cap identification, historical reference weight and pressure data stored in the Protective Cap's memory device by one Portable Meter, can later be retrieved by a different Portable Meter. The retrieved data accesses programming within the Portable Meter for the type of vehicle defined by the Meter Connects Protective Cap. This way, names included in the messages, instructions and warnings are relevant for the tractors, trailers or spread axle trailers as defined by the Protective Cap memory.

Another object of this invention is to teach that an electronic Portable Meter has an air sensor, battery, and a multi-line display and key-pad that are used as the user interface. The interface prompts the driver with messages through the scaling process and allows the driver to make user inputs appropriate for the vehicle being scaled. The user inputs allow the driver to define the name of the vehicle, view historical reference weight information that will be used in making a weight estimate, change and save new reference information to a memory devices, and display the axle weights and combination of axle weights.

Another object of this invention is to teach that the hand carried, Portable Meter is preferably battery powered but can be vehicle powered with one end of a quick-coupler system mounted to it and has a sensor built into it.

Another object of this invention is to teach a unique method of accessing the data stored on the Meter Connects' Protective Cap by placing the Protective Cap over the Portable Meter's quick-coupler port and pressing it against the Portable Meter's case. This develops an electrical circuit that transfers data between the Protective Cap and the Portable Meter. Internal to the Portable Meter, a self-generated voltage is placed on the unique hardware circuit developed by touching the components together which excites a protocol on the Memory device. Cap identification, reference weight and pressure data is read and written between the memory device in the cap and the circuit board components through the signal place on the voltage generated by the Portable Meter.

Another object of this invention is to teach a process of viewing reference axle weights just before making a weight estimate as an important change from previous patents. In previous patents, the empty axle weight and the loaded axle weight for each vehicle is obtained to form a line equation. This expression is an approximation of the actual non-linear weight to pressure relationships. As such, the estimated weights are most accurate at the reference weights and the most inaccurate between the reference weights.

The logic in the Portable Meter of this patent differs in two ways. First, determining and entering the empty axle weight for every vehicle is not only logistically impractical for large fleets, but lowers the accuracy that can be obtained. Instead, a shorter line segment of reference axle weights defining the axle weight working range the driver needs, improves axle weight estimating accuracy. It also makes obtaining reference weights easier because the empty axle weight is not required for each vehicle. Secondly, when an axle weight estimate is required that is outside the modeled reference weights, the scale warns the driver about the potential inaccuracy of using the scale in a working range that has not been modeled. If they continue the driver knows he should have a lower confidence in the weight estimate being made as it has not been modeled by historical reference weights. Other screens remind a driver that more reference weights are required to make an accurate weight estimate. If a wider range of axle weight estimates is required, the driver can obtain a new reference weight to include this range. If a full range of axle weights are required by a driver, more reference weights may be added within the working range used by the driver transforming the calculation into a non-linear function or an approximation of one.

During trouble shooting, a diagnostics screen assists the driver in assessing the current conditions and settings used to create the weight estimate.

Another object of this invention is to teach that the Portable Meter is then temporarily coupled to the quick-coupler on the Meter Connect to sample the suspension air bag pressure. The pressure is converted to weight by the Portable Meter and displayed to the operator in meaningful axle weight units.

The Portable Meter may have communications components within it to transfer a single or range of observations and what their sensor readings represent in engineering units as defined by each Meter Connect, to a printer or other communications device. This can be is used to provide a receipt to a customer, transfer the data gathered by the Portable Meter, or in some other way communicate with some other electronic device.

Another object is to teach that the sensor within the Portable Meter and different quick-couplers chosen to monitor the pressure of some other medium such as hydraulic fluid as well.

Another object of this invention is to teach that other types of sensors mounted outside the Portable Meter could be monitored by first touching the Portable Meter to a permanently mounted memory device. This would load the reference information for converting sensor output data into engineering units and define which group of pre-programmed user interfaces should be displayed. Then, the Portable Meter would be temporarily electrically connected to monitor sensor output. The Portable Meter, through the pre-programmed user interfaces, would display the converted data in the engineering units defined by the memory device and save it for retrieval at a later date.

The final object of this invention is to teach that the application of this methodology and technology is not limited to the onboard truck scaling industry. There are many industrial applications in many industries where because of the low accuracy and durability of traditional gages, an electronic monitoring device may be required. However, because of their high initial cost and high level of maintenance, a lower cost alternative may be required. This system provides highly accurate measurement in a durable package at the lowest permanent asset cost.

### A BREIF DESCRIPTION OF THE DRAWINGS

In the accompanying drawings which form a part of the specification:

FIG. 1 shows a side view of the Portable Meter with the quick-coupler port.

FIG. 2 shows a face view of the display and the key-pads mounted in the Portable Meter and the quick-coupler mounted to the side of it.

FIG. 3 is an internal view of the conductive meter case and components assembled to transfer data between the Protective Cap's memory and a circuit board within a Portable Meter.

FIG. 4 is an internal view of a non-conductive meter case and components assembled to transfer data between the Protective Cap's memory and a circuit board within a Portable Meter.

FIG. 5 is a view of a Meter Connect Assembly that will be used by the Portable Meter to sample the pressure within a truck suspension's air bag.

FIG. 6 is a view of a Protective Cap that will cover the quick-coupler fitting on the Meter Connect Assembly and supply the electrical connections to transfer data from the Protective Cap's memory to the Portable Meter.

FIG. 8 is a view of the Protective Cap's memory device.

### DETAILED DESCRIPTION OF THE INVENTION INVENTION DETAILS

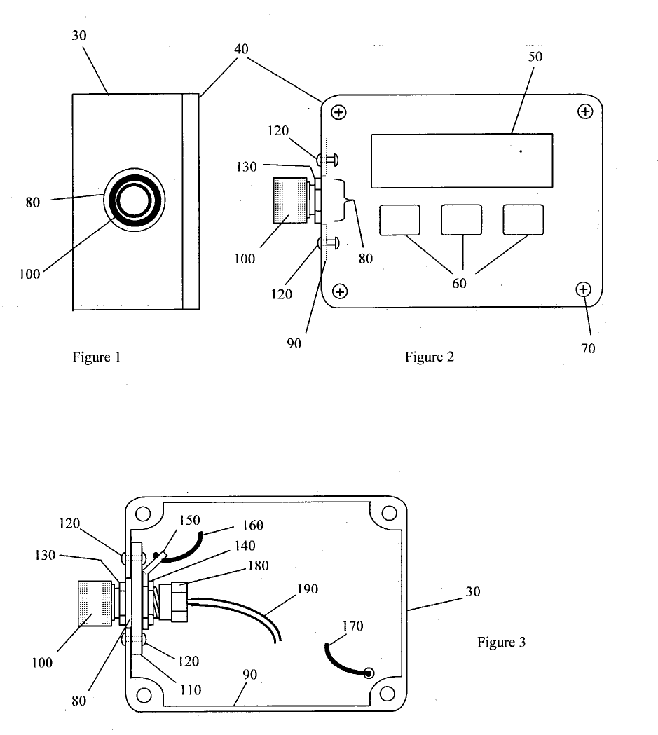

The component of this invention that is portable is the Portable Meter and shown in FIGS. 1, 2, 3, and 4. It is comprised of a case that can be constructed of plastic, aluminum, or some other suitable conductive material, that has a bottom (30) and a top (40). In the preferred design the case is made of a conductive material such as aluminum. An alpha-numeric display (50) is positioned either in the bottom (30) or top (40) of the case. The display (50) can be a single or multiple line display that prompts the operator how to operate the system, what to do next, and/or displays data.

The operator interfaces with the Portable Meter through the display (50) and a key pad (60) with between one and fifty keys. Three keys are shown in the preferred design. In the preferred design both the display (50) and key pad (60) are mounted in the case top (40). The top (40) and bottom (30) of the case is joined by screws, other mechanical fastener means, or a design where the top (40) and bottom (30) components are mated together by friction fit. The preferred design show them joined with screws (70).

In the conducive case of FIG. 3, a cut-out (80) is made through the thickness (90) in either the top (40) or bottom (30) or both parts of the case that is large enough so the quick-coupler fitting (100), also being conductive, does not touch the top (40) or bottom (30) of the conductive case.

In the conducive case of FIG. 3, a non-conductive material (110) is attached with a fastener (120) to the case (30) or (40). The preferred fastener (120) is an aluminum rivet but the fastener (120) can be made of any suitable material. The non-conductive material (110) has a hole in it through which the quick-coupler (100) is screwed into or inserted through. The quick-coupler (100) is held in place by retaining nuts (130) and (140) placed on either side of the non-conductive material (110) or by a single retaining nut (140) and a nut head manufactured onto the quick-coupler fitting (130).

In the conducive case of FIG. 3, beneath the inner retaining nut (140) is a conductive bent washer (150) with an insulated electrical wire (160) joined to it. In this configuration, there is electrical conductivity from the tip of the quick-coupler (100) to the end of the insulated electrical wire (160) through the quick coupler (100) and conductive bent washer (150). The conductance of this circuit is electrically insulated from the conductive case (30) and (40) in FIG. 3 and from an electrically conductive wire attached to the case (170). The loose ends of electrical wires (160) and (170) are to be attached to a circuit board within the case.

A reducing nipple (180) is attached to the quick-coupler (400) so that a flexible hose (190) can transfer the pressure to sensor on the circuit board inside the case.

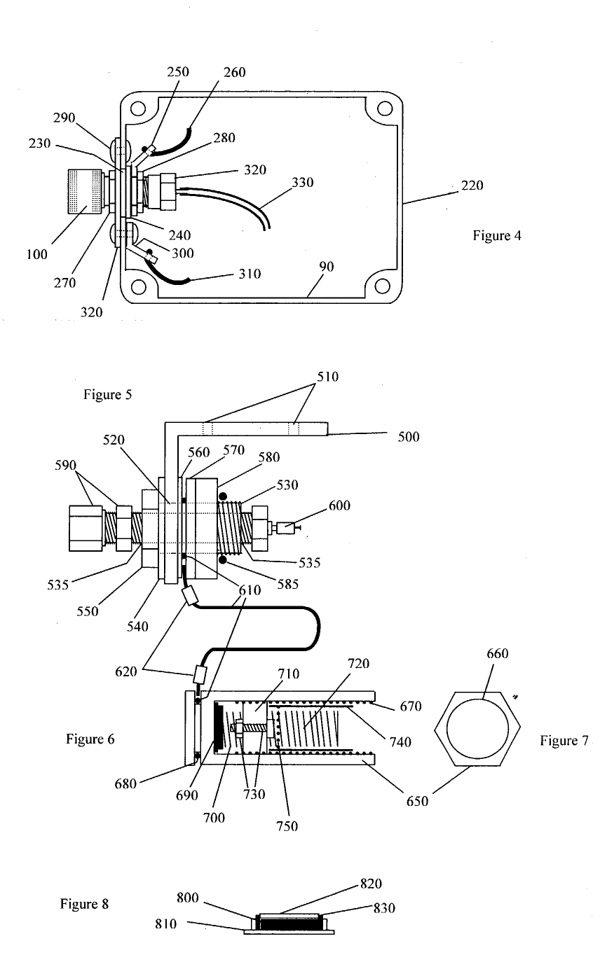

In the non-conducive case (220) of FIG. 4, a cut-out (230) is made through the thickness (90) of the case that that is large enough so the quick-coupler fitting (100), can be placed through the hole (230). In the non-conductive case of FIG. 4, it does not matter if the quick-coupler (100) touches the top (40) or bottom (30) of the case. Inside the case, a spacer (240) may be required followed by a conductive bent washer (250) with an insulated electrical wire (260) joined to it. In this configuration, there is electrical conductivity from the tip of the quick-coupler (100) through the conductive bent washer (250), to the end of the insulated electrical wire (260). The quick-coupler (100) is held in place by retaining nuts (270) and (280) placed on the inside and outside of the non-conductive case (220) or by a single retaining nut (280) and a nut head (270) manufactured onto the quick-coupler fitting (100).

Through a hole in the case of FIG. 4 is one or more conductive fasteners (290) shown as an aluminum rivet in the preferred design. Inside of the case, the conductive fastener (290) holds a conductive bent washer (300) with an insulated electrical wire (310) joined to it. Outside the case the fasteners (290) join an optional conductive washer (320). The fastener (290) and optional conductive washer (320) are located far enough away to be electrically insulated from the quick-coupler (100). The fasteners (290) and optional conductive washer (320) is, however, located close enough to the quick-coupler (100) so that when the Portable Meter quick-coupler (100) is inserted into the drill cavity (660) of the Protective Cap (650) in FIG. 7, the Protective Cap (650) touches the conductive fastener (290) or the optional conductive washer (320). The unattached ends of the electrical wires (260) and (310) are attached to a circuit board within the case.

A reducing nipple (320) is attached to the quick-coupler (100) so that a flexible hose (330) can transfer the pressure to sensor on the circuit board inside the case.

The component of this invention that is permanently mounted to the tractor or trailer is shown in FIGS. 5, 6, and 7 and collectively called the Meter Connect. In FIGS. 6 and 7 is shown a component called the Protective Cap.

In FIG. 5, a short piece of angle iron (500) has two mounting holes in one leg (510) and a larger hole in the opposite leg (520). A bulkhead fitting has a hex head on one end (550) and a threaded end on the other (530). Through the bulkhead is a threaded hole (535) with an air line compression fitting (590) screwed into the hex head end of the bulkhead (550). The bulkhead is make of brass in the preferred design.

The threaded end of the bulkhead (530) may have a spacer washer (540) inserted over it before the assembly is inserted into the larger hole of the angle iron (520). Another spacer or star washer (560) may be placed over the outer threads of the bulkhead (530) followed by a length of non-conductive line formed into a loop (610) and inserted into a ferrel (620). The ferrel (620) is made of a material that can be deformed to hold the length of non-conductive line (610) so the loop it forms just fits over the threaded end of the bulkhead (530). The purpose of the non-conductive line (610) is to keep the assembly in FIG. 6 attached to the assembly in FIG. 5 when the two are not screwed together with threads (670) of FIG. 6 and (530) of FIG. 5. The line is non-conductive so it electrically insulates the Protective Cap (650) of FIGS. 6 and 7 from the Meter Connect assembly in FIG. 5 that is attached permanently to the trailer or tractor. Nylon line is preferred. This keeps any electronic noise or digital data on the truck or trailer from contaminating the data stream being sent between the Protective Cap and the Portable Meter.

A lock washer (570) then a bulkhead nut (580) is placed over the bulkhead threads (530) and tightened to hold the assembly in place. Quick-coupler fitting (600) is the mating quick-coupler component to fitting (100) in FIGS. 3 and 4. Quick-coupler fitting (600) is threaded into the threaded through-hole (535) of the bulkhead (530). In the preferred design, the quick-coupler fitting (600) is a male fitting and all the coupler components are Brass. An O-ring (585) is placed over the outer threads (530) of the bulkhead to provide a friction fit between the Meter Connect assembly of FIG. 5 and the Brass Cap assembly of FIG. 7. This is done so the components do not vibrate apart when screwed together.

The Meter Connect assembly of FIG. 5 may be used without being assembled in the angle iron (500) and inserted through any hole in the frame or permanent vehicle component.

In FIGS. 6 and 7 a Protective Cap is formed by a conductive material (650) that has a hole drilled into it (660) and threaded (670). Brass is used in the preferred design. A memory device shown in FIG. 8 is constructed with the memory (800) placed in a conductive base (810) and a conductive top (820) that are electrically insulated (830) forming what the electronic industry calls a memory button. The top (820) and bottom (810) of the case in the preferred design are stainless steel. With the appropriate electrical signals and protocols between the top (820) and bottom (810) of the memory case (690) data can be stored onto and later retrieved from the memory device (800).

The memory device of FIG. 8 is placed in the bottom of the drilled hole (660) so the bottom (810) of the memory device case (690) shown in FIG. 6 is in contact with the conductive material (650) at the bottom of the hole (660). The top of the memory device case (820) is in contact with a small conductive spring (700).

A threaded non-conductor (710) has a small conductive spring (700) attached to one side of it and a larger conductive spring (720) attached on the other side of it. The springs (700) and (720) are attached through the non-conductor (710) with a conductive fastener (730). This allows electricity to flow from one end of the smaller spring (700) through the fastener (730) and through the larger spring (720). The non-conductor (710) has threads on its outer diameter so it can be threaded into the threaded hole of the conductive material (670) with the small spring (700) inserted first. The smaller spring (700) can not touch the threads (670) of the conductive material (650) but only touches the top 20 (820) of the memory device (690).

A thin insulator (740) of the appropriate diameter is placed between the threads (670) of the conductive material (650) and the larger spring (720) along the entire length of the spring. In the preferred design a flat non-conductive plastic sheet is cut to size, rolled, and inserted between the threads (670) of the conductive material (650) and the larger spring (720). Water is kept from the chamber that holds the memory device (690) and the smaller spring (700) by a sealing material (750) such as a pourable silicone in the preferred design. The sealing material (750) seals the mating thread imperfections (670) and (710), seals the fastener hole (730) forming a water seal and also holds the insulator (740) from exiting the hole (660).

### Method of Operation

To start the weight estimation process, the Portable Meter of FIGS. 1, 2, 3, and 4 is hand carried to a Meter Connect of FIGS. 5, 6, and 7. The Protective Cap of FIGS. 6 and 7 being part of and attached to the Meter Connect of FIG. 5 is unscrewed from the outer bulkhead threads (530) where it protects the quick-coupler fitting (600) and the larger spring (720) from dirt and water. The Protective Cap is kept from vibrating off of the bulkhead threads (530) while in transit by friction between the threads (530) and (670) caused by an O-ring (585) over the bulkhead threads (530).

The Portable Meter is preferably battery powered but can be vehicle powered with one end of a quick-coupler or other sampling coupler system mounted to it and has a sensor built into it. It is capable of reading and writing information between the memory device (690) within the Protective Cap of FIGS. 6 and 7 and the Portable Meter. To do so, a non-obvious electrical circuit has been devised within the components this invention.

As a finished assembly, the data on the memory device (690) within the Protective Cap of FIGS. 6 and 7 is transferred between the memory device (690) and a circuit board within the case (30). This is done by positioning the hole (660) of the Protective Cap (650) over the Portable Meters quick-coupler port (100) until the larger spring (720) within the Protective Cap, touches the Portable Meters quick-coupler (100) and simultaneously the Protective Cap's outer conductive rim (650) touches the conductive case (30), the conductive fasteners (290), or conductive washer (320). The components form an electrical circuit for connecting the memory device (690) within the Protective Cap of FIGS. 6 and 7 to a circuit board within a conductive or non-conductive case (30).

While the Protective Cap is pressed over the quick-coupler (100) to the larger spring (720) there is electrical conductivity from the top (820) of the memory device case (690) to the electrical wire (260) within the case for connection to the circuit board.

As the Protective Cap continues to be pressed toward the case (30), the rim of the conductive material (650) is pressed against the conductive washer (290), or conductive fastener (320) of FIG. 4 or the conductive case (30) and (40) of FIG. 3 and makes an electrical connection. In this way, there is electrical conductivity from the bottom (810) of the memory device case (690) through the conductive Protective Cap material (650), through either the conductive case (30), the conductive washers (320), and/or the conductive fasteners (290), through the bent washer (300), and through the electrical wires (310) or (170). These wires are connected to and form the electrical ground on the circuit board in the preferred design.

This develops an electrical circuit that transfers data between the Protective Cap and the Portable Meter. Internal to the Portable Meter, a self-generated voltage is placed on the unique hardware circuit developed by touching the components together which excites a protocol on the Memory device (800).

On the circuit board a microprocessor receives inputs from a sensor and key pads (60). The microprocessor drives the logic and the projection of operational instructions, questions, operator warnings, and ultimately sensor feedback that has been converted to usable data on the user interface display (50).

To convert the sensor feedback into usable data, the sensor data must be related to axle weights or engineering units. This is a process of defining the scales working range by developing reference information for the axle or axles to be scaled by relating a lower suspension air pressure to a lower axle weight and a higher suspension air pressure to a higher axle weight. Additional reference weights and pressures, if added, can form the basis for non-linear equations or multiple line segments used in the calculation of axle weights. The key pads (60) on the Portable Meter are used to answer operational questions, turn on and off the meter, input the correct current axle weight as displayed (50) on the Portable Meter, and store the current pressure as a reference weight. The weights and pressures are stored on the memory device (690) for each axle or group of axles.

Once turned on, the display (50) prompts or reminds the driver to perform the next step of the weighing process. Initially it is to Press the Protective Cap over the Meters quick-coupler. The purpose of this, as described above, is to identify what type of vehicle the Protective Cap has been installed on and read the reference pressures and weights into the Portable Meter.

The Portable Meter uses the cap identification to access programming specific to the type of vehicle being scaled. This programming includes: the types of user interface questions asked on the display, the name of the vehicle represented by the vehicle code stored on the Protective Cap, the names of axles to be scaled associated with that vehicle, and the formula used in converting the weight and pressure information into axle weights.

One screen will offer to display the reference weights that will be used to make a weight estimate. Viewing the reference weights increase a driver's confidence in the weight estimate as weight estimates are most accurate near reference weights. Estimates are also more accurate when defined by a shorter working range of reference weights. This is because axle weight to sensor output profiles are non-linear functions. If the weight estimate required is outside of the modeled range as defined by the reference weights for that axle or axle group, the Portable Meter delivers a warning to the driver that the observation is outside of the weight estimating range and asks if they would like to continue. If they continue, the driver knows he should have a lower confidence in the weight estimate being made by the Portable Meter as it has not been modeled by historical reference weights. The driver can at anytime redefine a wider working range by obtaining a new reference weight that includes the desired weight observation. Other screens remind a driver that more reference weights are required to make an accurate weight estimate.

During trouble shooting, a diagnostics screen assists the driver in assessing the current conditions by displaying current sensor reading and settings used to create the weight estimate. It also displays a higher resolution of data that is typically shown on the meter.

The Portable Meter will prompt a driver to attach the Portable Meter to the quick-coupler or other sampling coupler on the Meter Connect to obtain the current pressure for making a weight estimate. In the preferred embodiment, with the pressure read, the logic determines the linear line segment represented by the reference weights and pressures, and returns a weight estimate. If more than two reference weights and pressures are present, the logic may alternately determine which reference pressures are closest to the actual pressure being read, whether both higher, both lower, or on either side of it, and develop a line segment to make a weight estimate. Alternately, a non-linear equation may be used to make a weight estimate from the reference weight and pressure information if enough information is present.

The Portable Meter may have communications components within it to transfer a single or range of observations and what their sensor readings represent in engineering units as defined by each Meter Connect, to a printer or other communications device. This can be is used to provide a receipt to a customer, transfer the data gathered by the Portable Meter, or in some other way communicate with some other electronic device.

When making a weight estimate, two or more axles may be pneumatically tied together so all axle groups will have the same suspension pressure and can be referred to as one axle group in the development of reference data. Conversely, a group of two or more axles may be pneumatically lied together but the weight of each axle is displayed individually by axle name. The programming of the Portable Meter of FIGS. 1, 2, 3, and 4 allows both of these methods of determining current axle weight or axle group weight from the data stored on one Protective Cap of FIGS. 6, and 7.

A third method of storing weights and pressures on a Protective Cap is available for when an axle or group of axles does not have a sensor directly mounted to the axle or group of axles. Such is the case in estimating the front axle weight when the front axle is spring suspended. The weight carried by the front and drive axles is distributed to the axles by the 5^{th} wheel. While the 5^{th} wheel remains in a single location, the pressure within the drive axle suspension system can be used to estimate both the drive axle weight directly and the front axle weight indirectly. With historical weight data of front axle weights in various 5^{th} wheel positions while reading the drive axle suspension pressure, the front axle weight can be estimated when the driver inputs his current the 5^{th} wheel location after reading drive axle suspension pressure.

Thus, one Protective Cap shown in FIGS. 6, and 7 can be taught to function in any of three ways. First, as a tractor Protective Cap with both front and drive axles where the suspension pressure of one axle estimates the weights for both axles. Secondly, as a typical trailer with two close axles called a tandem where the weight of both axles are not displayed individually, but as a group weight estimated from sampling the groups suspension pressure. Thirdly, as a spread tandem where the suspension pressure of both axles is the same but they are calibrated to represent different weights for each axle.

This methodology and technology of monitoring and converting sensor output to meaningful engineering units could be used for a variety of sensor types in a variety of axle weighing applications. Other sensors mounted within the case could measure the pressure of fluids when combined with appropriate quick-couplers.

Though a slight modification, other types of sensors mounted outside the Portable Meter could be monitored by first touching the Portable Meter to a permanently mounted memory device. This would load the reference information for converting a sensors output data into engineering units and define which group of pre-programmed user interfaces should be displayed. Then, the Portable Meter would be temporarily electrically connected to monitor sensor output. The Portable Meter would display the converted data in the engineering units defined by the memory device and save it.

The application of the methodology and technology taught in this patent is not limited to the onboard truck scaling industry. There are many industrial applications in many industries where because of the low accuracy and low durability of traditional gages, electronic monitoring devices are required. However, because of an electronic monitoring devices high initial cost and high level of maintenance, a lower cost alternative is required. The methodology and technology taught in is patent provides highly accurate measurements in a durable package at the lowest permanent asset cost.

Having thus claimed the invention, what is claimed is:

1. A process of onboard truck scaling without a sensor permanently attached or included as part of an assembly that is permanently attached to a vehicle that may or may not be powered from the vehicle.

2. A process of electronic onboard truck scaling not tapping into electrical wiring currently existing on a vehicle for the purpose of powering, data transfer, or communications.

3. A process of onboard truck scaling where a Meter Connect Assembly that is permanently attached to a vehicle is comprised of a quick-coupler fitting or sampling port with a Protective Cap.
the quick-coupler or sampling port is coupled to a suspension air line, that is coupled to a suspension air bag.
the Protective Cap on the Meter Connect Assembly functions as a protective dust cap, a memory device storage location, and an electrical conduit for transferring data between the memory device and a Portable Meter.

4. A process of claim 3 where the Meter Connect Assembly may be removed from its angle iron mounting and the Assembly affixed to a vehicle through some other hole on the vehicle.

5. A process of onboard truck scaling where a Portable Meter comprised of a sensor, battery, and circuit board located inside a conductive or non-conductive case that has a quick-coupler fitting or other sampling coupler mounted to it.
The Portable Meter uses the conductive or non-conductive case and additional conductive and non-conductive components attached to the case to create the electrical conduit to transfer data between the memory device within the Protective Cap and the circuit board within the case of the Portable Meter.

6. A process of claim 5 where a voltage generated by the Portable Meter is placed on the unique hardware circuit developed by touching the components together. This excites a protocol on the memory device to transfer data between the Portable Meter and the memory device imbedded in the Protective Cap, which is attached to a Meter Connect.

7. A process of claim 5 where the Portable Meter is capable of accessing and storing historical weight, sensor, and other vehicle profile information specific to that vehicle on a memory device imbedded in the Protective Cap, which is attached to a Meter Connect, that is attached to the vehicle.

8. A process of claim 5 where the Portable Meter can transfer vehicle specific data, a single or range of sensor observations and what the observations represent in engineering units as defined by each Meter Connect, to a printer or other communications device either on or off of the vehicle.

9. A process of claim 5 where a driver diagnostics screen on the Portable Meter assists the driver in assessing the current conditions and settings used to create the weight estimate by pressing a combination of keys on the key-pad.

10. A process of onboard truck scaling where the Protective Cap or some other housing containing a memory device is touched to the Portable Meter to transfer data between each other through and electrical conduit created by the Protective Cap and Portable Meter.

11. A process of claim 10 where the data transferred identifies vehicle specific information, how many axle weights will be estimated with this sensor reading, and how the sensor output and logic should be applied to the calculation of axle weight.

12. A process of onboard truck scaling where reference axle weights define a scales working range. Where the Portable Meter screen will offer to display the reference weights that will be used to make a weight estimate to increase the driver's confidence in the weight estimate.

13. A process of onboard truck scaling where the Portable Meter is temporarily connected to the quick-coupler or other sampling coupler on the Meter Connect to sample air bag pressure on a trucks suspension system.

14. A process of onboard truck scaling where other Portable Meter screens remind a driver when more reference weights are required to make an accurate weight estimate for an axle or group of axles.

15. A process of onboard truck scaling where if an axle weight estimate is required that is outside the line segment defined by the reference weights, the scale warns the driver about the potential inaccuracy of using the scale in a working range that has not been modeled. If a wider range of axle weight estimates is required, the driver can obtain and store a reference weight and pressure to model this range.

16. A process of onboard truck scaling where if a full range of axle weights are required by a driver, more than two reference weights and pressures may be added within the working range. If more than two reference weights and pressures are present, the logic determines which reference pressures are closest to the actual pressure being read, whether both higher, both lower, or on either side of it, and develop a line segment to make a weight estimate. Alternately, a non-linear equation may be used to make a weight estimate from the reference weight and pressure information if enough information is present.

17. A process where the claims 1 through claim 16 can be applied to monitor the engineering units of pressure for other types of mediums other than air.

18. A process where the claims 1 through claim 17 can be applied to sensors not mounted within the Portable Meter.

19. A process where claims 1 through claim 18 are not limited to the onboard truck scaling industry. Rather, this process has an application in every sensor application in any industry.
